(19) United States
(12) Patent Application Publication
(10) Pub. No.: US 2016/0139673 A1
(43) Pub. Date: May 19, 2016

(54) ROTATING DISPLAY CONTENT RESPONSIVE TO A ROTATIONAL GESTURE OF A BODY PART

(71) Applicant: INUITIVE LTD., Ra'anana (IL)

(72) Inventor: Liron SALAMON, Ra'anana (IL)

(21) Appl. No.: 14/898,752

(22) PCT Filed: Jun. 12, 2014
(86) PCT No.: PCT/IL2014/050530

§ 371 Date: Dec. 16, 2015

Related U.S. Application Data
(60) Provisional application No. 61/841,456, filed on Jul. 1, 2013.

(51) Int. Cl. G06F 3/01; G06T 3/60

(52) U.S. Cl. CPC G06F 3/017; G06F 3/012; G06T 3/60

(57) ABSTRACT

A method and a system for rotating content of an electronic display responsive to rotational human gestures are provided herein. The system that implements the method may include: a display; at least one capturing device configured to capture a body part in front of said display; a processor; a rotational gesture recognition module executed by the processor and configured to detect a predefined rotational gesture and to generate an instruction to rotate the content of the display in approximately 90° only when the rotational gesture displacement goes beyond a predefined threshold.

### FIELD OF THE INVENTION

The present invention relates generally to the field of electronic displays and more specifically for controlling same via natural user interface.

### BACKGROUND OF THE INVENTION

Rotating a screen or content displayed on the screen of a PC, laptop, mobile device or notebooks is an everyday task and is required for ergonomic reasons. For example, a chef cooking a dish according to a recipe taken from the notebook that lays on the kitchen table. A user eating a hamburger while watching a movie. A dentist working his way in patient's mouth while looking at the X-Ray.

When a user views the screen and desires to rotate this screen or image (portrait to landscape or vice versa), he is required to do so by rotating the device, if it is a mobile device or notebook. If the user is using a laptop or PC the rotation will be acquired by applying a specific action according to the application used in the computer. For example, if the application is an image viewer, the user will need to press on the [symbol] icon—different icons or steps in different applications.

With a PC or a laptop this requires the user to know how to implement this rotation in the application he uses and in a mobile device or notebook the user is required to hold the device and rotate it.

### BRIEF SUMMARY

According to some embodiments of the present invention, a method and a system for rotating content of an electronic display responsive to non-touch rotational human gestures are provided herein. The system that implements the method may include: a display; at least one capturing device configured to capture a body part in front of said display; a processor; a rotational gesture recognition module executed by the processor and configured to detect a predefined rotational gesture which generates instructions to the operating system or to a display control module which is a part of the existing device. The generated instruction invokes the display control module to rotate the content of the display in approximately 90° only when the rotational gesture is completed. Determining that the rotational gesture has been executed in full may be carried out, for example by detecting a displacement of the bodily part beyond a predefined threshold.

These additional, and/or other aspects and/or advantages of the present invention are set forth in the detailed description which follows.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 is a diagram illustrating an environment of the system according to embodiments of the present invention;

FIG. 2 is a block diagram illustrating one aspect of a system according to embodiments of the present invention;

FIG. 3 is a high level flowchart diagram illustrating an aspect of a system according to embodiments of the present invention; and

FIG. 4 is a diagram illustrating an aspect according to embodiments of the present invention.

The drawings together with the following detailed description make the embodiments of the invention apparent to those skilled in the art.

### DETAILED DESCRIPTION OF EMBODIMENTS OF THE INVENTION

With specific reference now to the drawings in detail, it is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

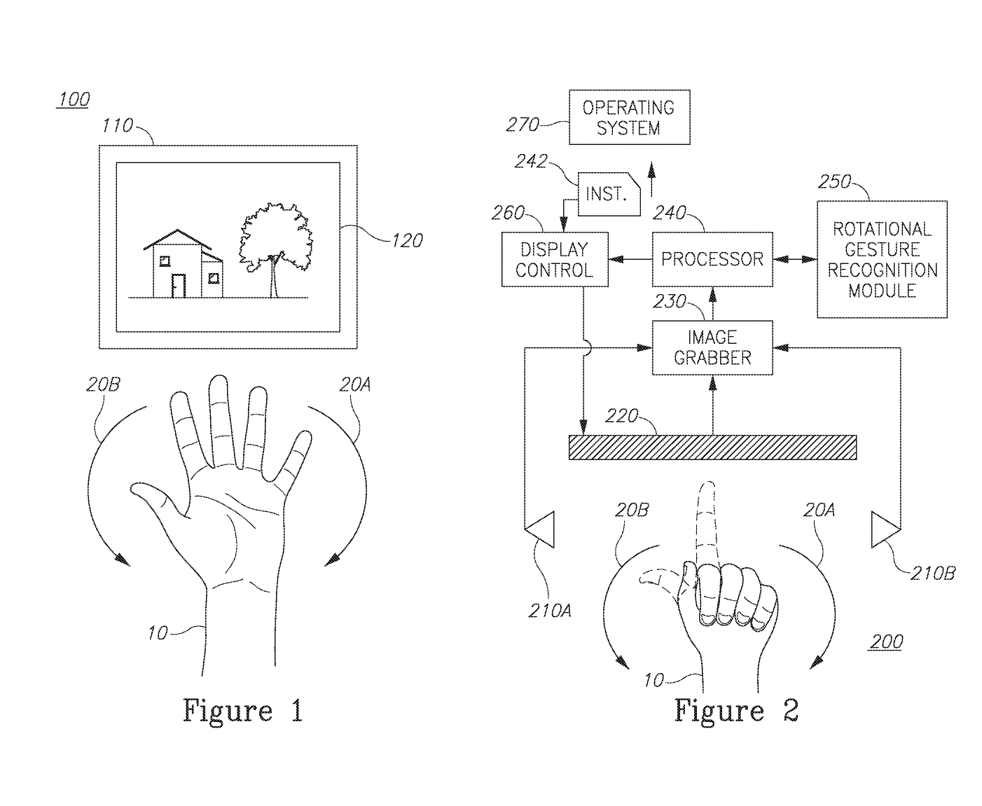

FIG. 1 is a diagram illustrating an environment 100 of the system according to embodiments of the present invention. A device 110 which contains a display 120 is equipped with image capturing means (not shown here) that may capture a body part of a user such as hand 10 carrying out rotational gesture which may be, for example clockwise 20A or counterclockwise 20B or similar that in turn invoke rotation of the displayed content 120.

Advantageously, in embodiments of the present invention, the user is not required to make a learning effort or extra physical effort. With the gesture 20 of the user's finger in circular motion, the screen will rotate to give the user a better, easier and much more comfortable experience. For example, a chef will be able to rotate the screen without using his dirty hands. The user can continue watching the movie without putting his burger down. The dentist doesn't need to remove his gloves.

FIG. 2 is a block diagram illustrating one aspect of a system according to embodiments of the present invention. System 200 may be configured for rotating content of an electronic display responsive to rotational human gestures. System 200 may be implemented within a PC, laptop, smartphone or a large display. System 200 may include a display 220 with at least one capturing device 210A and 210B configured to capture a body part in front of display 220. System 200 may further include a processor 240 which may be a dedicated processor for managing natural user interface (NUI). System 200 may further include a rotational gesture recognition module 250 possibly executed by processor 240 and configured to detect a predefined rotational gesture, and generate an instruction 242 to rotate the content of the display in approximately 90° only when the rotational gesture displacement goes beyond a predefined threshold. In some embodiments, instruction 242 may be issued to the existing operating system 270 that interacts with display 220. In other embodiments, instruction 242 may be issued to a display control module 260 which may also be an existing element of the PC or the smartphone.

Without limiting the scope of the possible gestures or body parts involved, in some embodiments, the body parts used for the gesturing may include hands (palm, fingers) and the head. Some gestures may include twist of the body part so as to achieve a rotational effect and some include a full rotation around an axis.

According to some embodiments of the present invention, the processor is further configured to detect a predefined posture of the body part being a delimiter from which the rotational gesture displacement is calculated for threshold purposes. The posture would be an indication that the user may seek to rotate the display but this intention is validated by the subsequent gesture to its full extent (i.e., the threshold which is predefined).

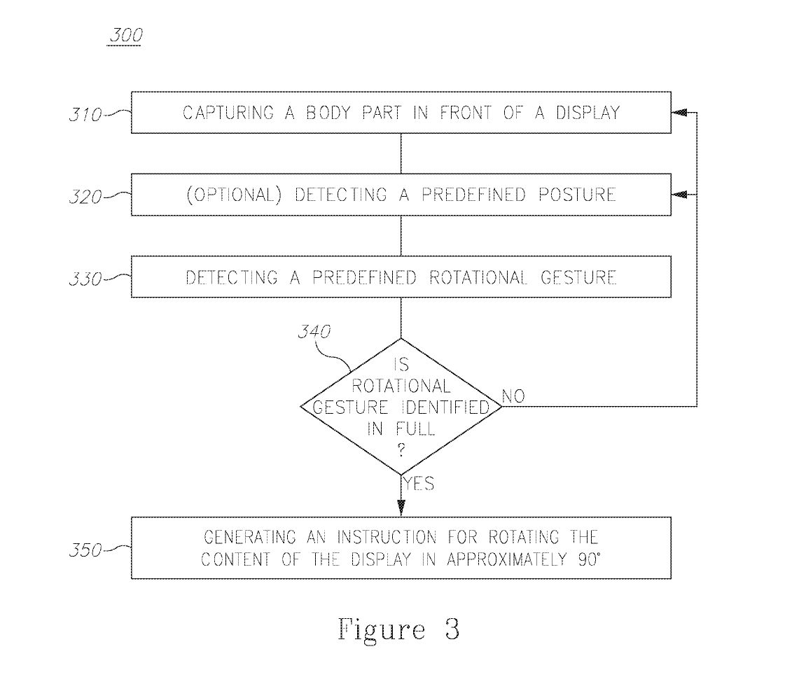

FIG. 3 is a high level flowchart diagram illustrating an aspect of a system according to embodiments of the present invention; Method 300 may be implemented for example by the aforementioned architecture of system 200. However, it is understood that the following stages of claim 300 need not necessarily be tied to a specific architecture. Method 300 may include the following stages: capturing a body part in front of a display 310; detecting a predefined rotational gesture; and generating an instruction to rotate the content of the display in approximately 90° 350 only when the rotational gesture is identified in full 340. The completion of the rotational gesture may be determined, by way of a non-limiting example, by identifying a displacement beyond a predefined threshold. In other cases, no instruction to change the orientation of the display content will be generated.

According to some embodiments of the present invention, method 300 may include another stage of detecting a predefined posture of the body part being a delimiter from which the rotational gesture displacement is calculated for threshold purposes 320. This is required for example, so that it will be apparent that a rotational gesture is being attempted and so the threshold of the extent of the full gesture may be measured. In other words, it would be sometimes simpler to define the rotational gesture with some sort of starting state being the aforementioned posture.

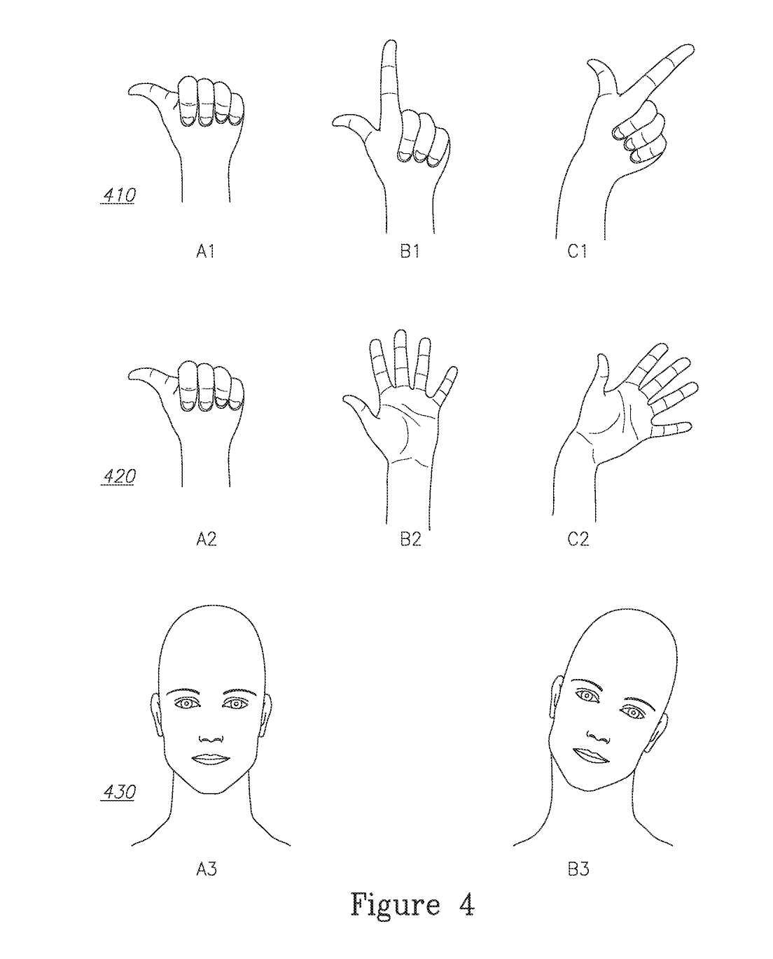

FIG. 4 is a diagram illustrating some non limiting examples for some rotational gestures and such according to embodiments of the present invention. A finger posture is illustrated in 410. Posture A1 shows a hand forming a fist with a thumb extended. In B1 the thumb and the pointing finger are extended. B1 may serve as a posture indicating the intention to rotate. By twisting it to position C1 the full gesture associated with the content rotation is achieved. It is understood that only the full gesture is effective in indicating that a rotation is required (i.e., a transition from B1 to C1). Partial gestures will not cause a rotation. This is required in order to reduce false positive events. The false negative events are achieved by selecting a gesture that is less likely to occur in normal user motor behavior.

In 420 positions A2 B2 and C2 show a similar sequence in which all fingers are extended both in the initial posture and in the twisting gestures. Only the detection of a full transition from B2 to C2 is regarded as a detected rotational gesture which invokes the instruction for the display device to rotate the content of the display.

In 430 positions A3 and B3 relate to using the head as the relevant body part. The gesture that defines the rotational gesture is a sideways rotation as seen in B3 for the full rotational gesture that invokes the displayed content rotation.

In accordance with some embodiments of the present invention, the user may further customize his or her environment and select several predefined gestures (e.g., head/hands/fingers) from a pool of optional gestures provided in advance. For example, the user may indicate, in a training stage, that only a head gesture as illustrated in 430 which include a transition from A3 to B3 will be regarded as an instruction to rotate the content. Alternatively, the user may indicate that in addition to the head gesture, also the hand gesture illustrated in 420 will be regarded as a rotation instruction, but not the finger gesture illustrated in 410. By having a pool of gestures the robustness of the detection algorithm is increased, thus reducing the likelihood of a false positive or a false negative scenario.

Alternatively and additionally, the user may be invited to generate and add one or more rotation gestures of his or her choice. The user generated gesture will be added into the set of ‘rotational gestures’ that will all be recognized as gestures that invoke a rotation of the content.

In some other embodiments, after every 90° rotation of the displayed content, a specified undo icon will appear on the screen. By selecting the undo icon, the rotation is canceled and the content is switched back to original orientation. The icon will fade from the screen after a predefined number of seconds.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
capturing a body part in front of a display;
detecting a predefined rotational gesture; and
generating an instruction to rotate the content of the display in approximately 90° only upon detecting a completion of the detected rotational gesture displacement.

2. The method according to claim 1, wherein the body part is a hand.

3. The method according to claim 1, wherein the body part is a head.

4. The method according to claim 1, further comprising detecting a predefined posture of the body part being a delimiter from which the rotational gesture displacement is calculated for threshold purposes.

5. The method according to claim 4, wherein the body part is a hand and wherein the predefined posture is one or more fingers extended from a palm of the hand.

6. The method according to claim 4, wherein the body part is a head and wherein the predefined posture is the head tilted at a predefined angle.

7. The method according to claim 1, wherein the instruction for rotating of the content of the display is aligned with a direction of the rotational gesture.

8. A system comprising:
a display;
at least one capturing device configured to capture a body part in front of said display;
a processor;
a rotational gesture recognition module executed by the processor and configured to detect a predefined rotational gesture and generate an instruction to rotate the content of the display in approximately 90° only when the rotational gesture displacement goes beyond a predefined threshold.

9. The system according to claim 8, wherein the body part is a hand.

10. The system according to claim 8, wherein the body part is a head.

11. The system according to claim 8, wherein the processor is further configured to detect a predefined posture of the body part being a delimiter from which the rotational gesture displacement is calculated for threshold purposes.

12. The system according to claim 11, wherein the body part is a hand and wherein the predefined posture is one or more fingers extended from a palm of the hand.

13. The system according to claim 11, wherein the body part is a head and wherein the predefined posture is the head tilted at a predefined angle.

14. The system according to claim 8, wherein the instruction for rotating of the content of the display is aligned with a direction of the rotational gesture.

15. A tangible computer program product comprising:
a non-transitory computer readable storage medium having computer readable program embodied therewith, the computer readable program comprising:
computer readable program configured to capture a body part in front of a display;
computer readable program configured to detect a predefined rotational gesture; and
computer readable program configured to generate an instruction for rotating the content of the display in approximately 90° only when the rotational gesture displacement goes beyond a predefined threshold.

16. The computer program product according to claim 15, wherein the body part is a hand.

17. The computer program product according to claim 15, wherein the body part is a head.

18. The computer program product according to claim 15, further comprising computer readable program configured to detect a predefined posture of the body part being a delimiter from which the rotational gesture displacement is calculated for threshold purposes.

19. The computer program product according to claim 18, wherein the body part is a hand and wherein the predefined posture is one or more fingers extended from a palm of the hand.

20. The computer program product according to claim 18, wherein the body part is a head and wherein the predefined posture is the head tilted at a predefined angle.

21. The computer program product according to claim 18, wherein the instruction for rotating of the content of the display is aligned with a direction of the rotational gesture.
